(19) United States
(12) Patent Application Publication
(10) Pub. No.: US 2026/0065606 A1
(43) Pub. Date: Mar. 5, 2026

(54) SYSTEMS AND METHODS FOR PROCESSING SCANNED OBJECTS

(71) Applicant: Apple Inc., Cupertino, CA (US)

(72) Inventors: David A. LIPTON, San Mateo, CA (US); Zachary Z. BECKER, Issaquah, WA (US)

(21) Appl. No.: 19/379,644

(22) Filed: Nov. 4, 2025

Related U.S. Application Data
(63) Continuation of application No. 17/905,483.
(60) Provisional application No. 62/984,242, filed on Mar. 2, 2020.

(51) Int. Cl. G06T 19/00; G06T 7/507; G06T 15/80

(52) U.S. Cl. CPC G06T 19/006; G06T 7/507; G06T 15/80

(57) ABSTRACT

In some examples, while receiving captures of a first real world object, an electronic device displays a representation of a real world environment and a representation of the first real world object. In some examples, in response to receiving a first capture of a first portion of the first real world object and in accordance with a determination that the first capture satisfies one or more object capture criteria, the electronic device modifies a visual characteristic of the first portion of the representation of the first real world object. In some examples, an electronic device receives a request to capture the first real world object, and in response to the request, the electronic device determines a bounding volume around the representation of the first real world object and displays a plurality of capture targets on a surface of the bounding volume.

### CROSS-REFERENCE TO RELATED APPLICATIONS

This application is continuation of U.S. Patent App. Ser. No. 17/905,483, which is a National Phase application under 35 U.S. C. § 371 of International Application No. PCT/US2021/020062, filed Feb. 26, 2021, which claims the priority benefit of U.S. Provisional Application No. 62/984,242, filed Mar. 2, 2020, the contents of which are hereby incorporated by reference in their entireties for all intended purposes.

### FIELD OF THE DISCLOSURE

This relates generally to user interfaces that enable a user to scan real-world objects on an electronic device.

### BACKGROUND OF THE DISCLOSURE

Extended reality settings are environments where at least some objects displayed for a user's viewing are generated using a computer. In some uses, a user may create or modify Extended reality settings, such as by inserting extended reality objects that are based on physical objects into an extended reality settings.

### SUMMARY OF THE DISCLOSURE

Some embodiments described in this disclosure are directed to methods for electronic devices to scan a physical object for the purpose of generating a three-dimensional object model of the physical object. Some embodiments described in this disclosure are directed to methods for electronic devices to display capture targets for scanning a physical object. The full descriptions of the embodiments are provided in the Drawings and the Detailed Description, and it is understood that this Summary does not limit the scope of the disclosure in any way.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an example object scanning process in accordance with some embodiments of the disclosure.

FIG. 2 illustrates block diagrams of exemplary architectures for devices according to some embodiments of the disclosure.

FIG. 3 illustrates exemplary ways in which an electronic device scans real-world objects in accordance with some embodiments of the disclosure.

FIGS. 4A-4B illustrate exemplary ways in which an electronic device scans real-world objects and displays an indication of the scan progress in accordance with some embodiments of the disclosure.

FIGS. 5A-5C illustrate exemplary ways in which an electronic device displays targets for scanning real-world objects in accordance with some embodiments of the disclosure.

FIGS. 6A-6C illustrate exemplary ways in which an electronic device displays targets for scanning real-world objects in accordance with some embodiments of the disclosure.

FIG. 7 is a flow diagram illustrating a method of scanning a real-world object in accordance with some embodiments of the disclosure.

FIG. 8 is a flow diagram illustrating a method of displaying capture targets in accordance with some embodiments of the disclosure.

### DETAILED DESCRIPTION

In the following description of embodiments, reference is made to the accompanying drawings which form a part of this Specification, and in which it is shown by way of illustration, specific embodiments that are within the scope of the present disclosure. It is to be understood that other embodiments are also within the scope of the present disclosure and structural changes can be made without departing from the scope of the disclosure.

As used herein, the phrases “the,” “a,” and “an” include both the singular forms (e.g., one element) and plural forms (e.g., a plurality of elements), unless explicitly indicated or the context indicates otherwise. The term “and/or” encompasses any and all possible combinations of the listed items (e.g., including embodiments that include none of some of the listed items). The terms “comprises,” and/or “includes,” specify the inclusion of stated elements, but do not exclude the addition of other elements (e.g., the existence of other elements that are not explicitly recited in and of itself does not render an embodiment from not “including” or “comprising” an explicitly recited element). As used herein, the terms “first”, “second”, etc. are used to describe various elements, but these terms should not be interpreted as limiting the various elements, and are used merely to distinguish one element from another (e.g., to distinguish two of the same type of element from each other). The term “if” can be interpreted to mean “when”, “upon” (e.g., optionally including a temporal element) or “in response to”(e.g., without requiring a temporal element).

Physical settings are those in the world where people can sense and/or interact without use of electronic systems (e.g., the real-world environment, the physical environment, etc.). For example, a room is a physical setting that includes physical elements, such as, physical chairs, physical desks, physical lamps, and so forth. A person can sense and interact with these physical elements of the physical setting through direct touch, taste, sight, smell, and hearing.

In contrast to a physical setting, an extended reality (XR) setting refers to a computer-produced environment that is partially or entirely generated using computer-produced content. While a person can interact with the XR setting using various electronic systems, this interaction utilizes various electronic sensors to monitor the person's actions, and translates those actions into corresponding actions in the XR setting. For example, if an XR system detects that a person is looking upward, the XR system may change its graphics and audio output to present XR content in a manner consistent with the upward movement. XR settings may incorporate laws of physics to mimic physical settings.

Concepts of XR include virtual reality (VR) and augmented reality (AR). Concepts of XR also include mixed reality (MR), which is sometimes used to refer to the spectrum of realities between physical settings (but not including physical settings) at one end and VR at the other end. Concepts of XR also include augmented virtuality (AV), in which a virtual or computer-produced setting integrates sensory inputs from a physical setting. These inputs may represent characteristics of a physical setting. For example, a virtual object may be displayed in a color captured, using an image sensor, from the physical setting. As another example, an AV setting may adopt current weather conditions of the physical setting.

Some electronic systems for implementing XR operate with an opaque display and one or more imaging sensors for capturing video and/or images of a physical setting. In some implementations, when a system captures images of a physical setting, and displays a representation of the physical setting on an opaque display using the captured images, the displayed images are called a video pass-through. Some electronic systems for implementing XR operate with an optical see-through display that may be transparent or semi-transparent (and optionally with one or more imaging sensors). Such a display allows a person to view a physical setting directly through the display, and allows for virtual content to be added to the person's field-of-view by superimposing the content over an optical pass-through of the physical setting (e.g., overlaid over portions of the physical setting, obscuring portions of the physical setting, etc.). Some electronic systems for implementing XR operate with a projection system that projects virtual objects onto a physical setting. The projector may present a holograph onto a physical setting, or may project imagery onto a physical surface, or may project onto the eyes (e.g., retina) of a person, for example.

Electronic systems providing XR settings can have various form factors. A smartphone or a tablet computer may incorporate imaging and display components to present an XR setting. A head-mountable system may include imaging and display components to present an XR setting. These systems may provide computing resources for generating XR settings, and may work in conjunction with one another to generate and/or present XR settings. For example, a smartphone or a tablet can connect with a head-mounted display to present XR settings. As another example, a computer may connect with home entertainment components or vehicular systems to provide an on-window display or a heads-up display. Electronic systems displaying XR settings may utilize display technologies such as LEDs, OLEDs, QD-LEDs, liquid crystal on silicon, a laser scanning light source, a digital light projector, or combinations thereof. Display technologies can employ substrates, through which light is transmitted, including light waveguides, holographic substrates, optical reflectors and combiners, or combinations thereof.

Embodiments of electronic devices, user interfaces for such devices, and associated processes for using such devices are described. In some embodiments, the device is a portable communications device, such as a mobile telephone, that also contains other functions, such as PDA and/or music player functions. Other portable electronic devices, such as laptops, tablet computers with touch-sensitive surfaces (e.g., touch screen displays and/or touch pads), or wearable devices, are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad).

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

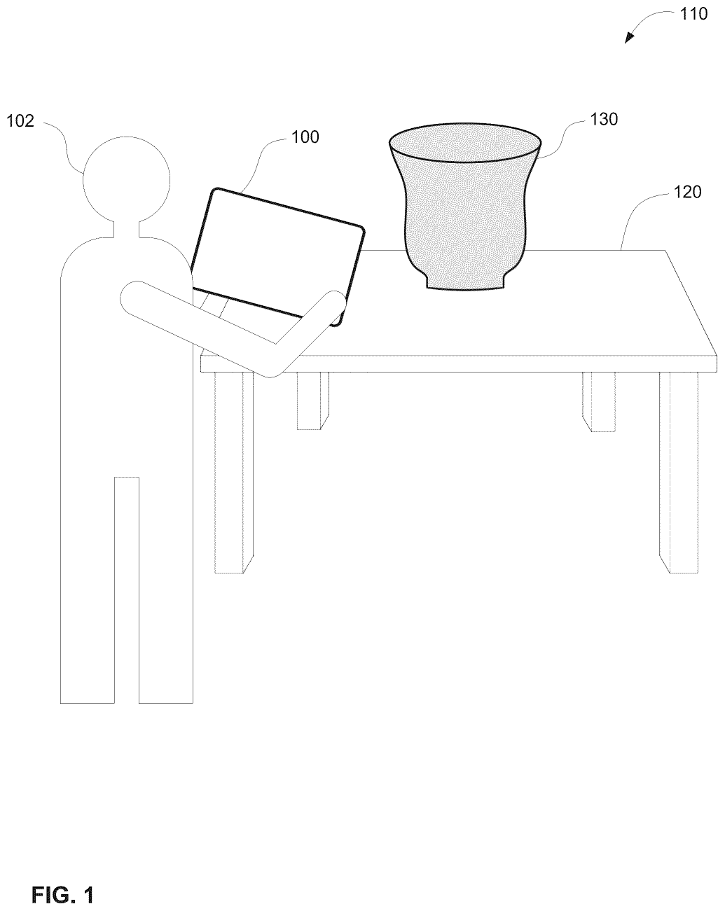

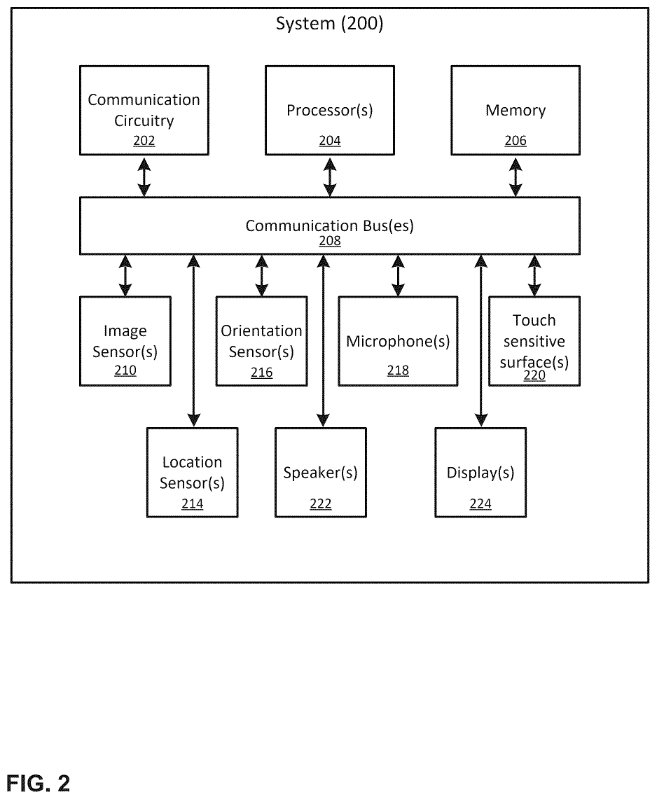

FIG. 1 illustrates user 102 and electronic device 100. In some examples, electronic device 100 is a hand-held or mobile device, such as a tablet computer or a smartphone. Examples of device 100 are described below with reference to FIG. 2. As shown in FIG. 1, user 102 is located in the physical environment 110. In some examples, physical environment 110 includes table 120 and vase 130 positioned on top of table 120. In some examples, electronic device 100 may be configured to capture areas of physical environment 110. As will be discussed in more detail below, electronic device 100 includes one or more image sensor(s) that is configured to capture information about the objects in physical environment 110. In some examples, a user may desire to capture an object, such as vase 130, and generate a three-dimensional model of vase 130 for use in an XR environment. The examples described herein describe system and methods of capturing information about a real-world object and generating a virtual object based on the real-world object.

Attention is now directed toward embodiments of portable or non-portable devices with touch-sensitive displays, though the devices need not include touch-sensitive displays or displays in general, as described above.

FIG. 2 illustrates a block diagrams of exemplary architectures for device 200 in accordance with some embodiments. In some examples, device 200 is a mobile device, such as a mobile phone (e.g., smart phone), a tablet computer, a laptop computer, an auxiliary device in communication with another device, etc. In some examples, as illustrated in FIG. 2, device 200 includes various components, such as communication circuitry (202), processor(s) 204, memory (206), image sensor(s) 210, location sensor(s) 214, orientation sensor(s) 216, microphone(s) 218, touch-sensitive surface(s) (220), speaker(s) 222, and/or display(s) 224. These components optionally communicate over communication bus(es) 208 of device 200.

Device 200 includes communication circuitry 202. Communication circuitry 202 optionally includes circuitry for communicating with electronic devices, networks, such as the Internet, intranets, a wired network and/or a wireless network, cellular networks and wireless local area networks (LANs). Communication circuitry 202 optionally includes circuitry for communicating using near-field communication and/or short-range communication, such as Bluetooth®.

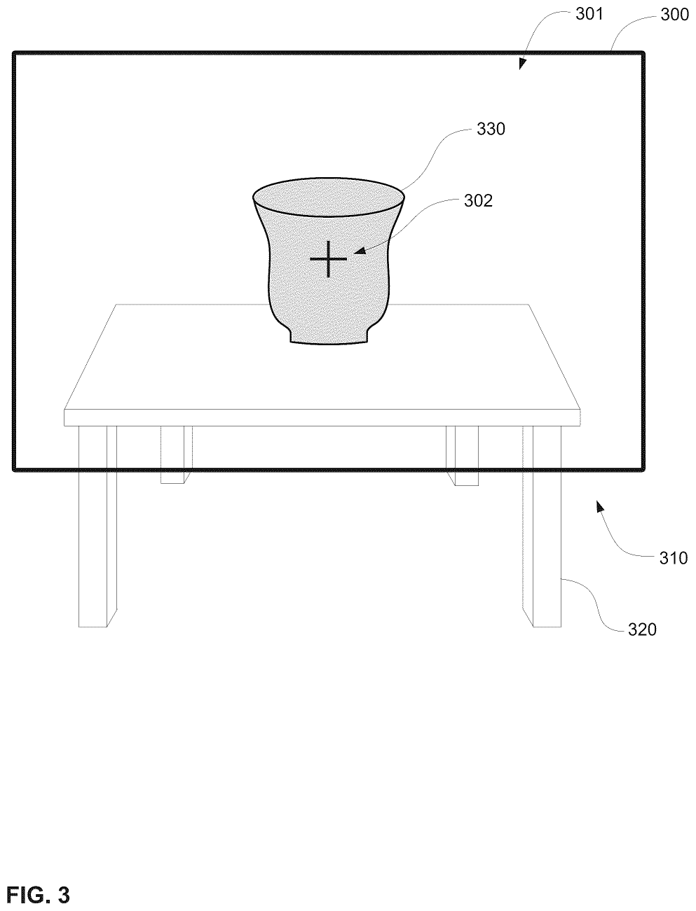

Processor(s) 204 include one or more general processors, one or more graphics processors, and/or one or more digital signal processors. In some examples, memory 206 are one or more non-transitory computer-readable storage mediums (e.g., flash memory, random access memory) that store computer-readable instructions configured to be executed by processor(s) 204 to perform the techniques, processes, and/or methods described below (e.g., with reference to FIGS. 3-7). A non-transitory computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like.

Device 200 includes display(s) 224. In some examples, display(s) 224 include a single display. In some examples, display(s) 224 includes multiple displays. In some examples, device 200 includes touch-sensitive surface(s) 220 for receiving user inputs, such as tap inputs and swipe inputs. In some examples, display(s) 224 and touch-sensitive surface(s) 220 form touch-sensitive display(s) (e.g., a touch screen integrated with device 200 or external to device 200 that is in communication with device 200).

Device 200 includes image sensor(s) 210 (e.g., capture devices). Image sensors(s) 210 optionally include one or more visible light image sensor, such as charged coupled device (CCD) sensors, and/or complementary metal-oxide-semiconductor (CMOS) sensors operable to obtain images of physical objects from the real environment. Image sensor(s) 210 also optionally include one or more infrared (IR) sensor(s), such as a passive IR sensor or an active IR sensor, for detecting infrared light from the real environment. For example, an active IR sensor includes an IR emitter, such as an IR dot emitter, for emitting infrared light into the real environment. Image sensor(s) 210 also optionally include one or more event camera(s) configured to capture movement of physical objects in the real environment. Image sensor(s) 210 also optionally include one or more depth sensor(s) configured to detect the distance of physical objects from device 200. In some examples, information from one or more depth sensor(s) can allow the device to identify and differentiate objects in the real environment from other objects in the real environment. In some examples, one or more depth sensor(s) can allow the device to determine the texture and/or topography of objects in the real environment.

In some examples, device 200 uses CCD sensors, event cameras, and depth sensors in combination to detect the physical environment around device 200. In some examples, image sensor(s) 210 include a first image sensor and a second image sensor. The first image sensor and the second image sensor work in tandem and are optionally configured to capture different information of physical objects in the real environment. In some examples, the first image sensor is a visible light image sensor and the second image sensor is a depth sensor. In some examples, device 200 uses image sensor(s) 210 to detect the position and orientation of device 200 and/or display(s) 224 in the real environment. For example, device 200 uses image sensor(s) 210 to track the position and orientation of display(s) 224 relative to one or more fixed objects in the real environment.

In some examples, device 200 includes microphones(s) 218. Device 200 uses microphone(s) 218 to detect sound from the user and/or the real environment of the user. In some examples, microphone(s) 218 includes an array of microphones (including a plurality of microphones) that optionally operate in tandem, such as to identify ambient noise or to locate the source of sound in space of the real environment.

Device 200 includes location sensor(s) 214 for detecting a location of device 200 and/or display(s) 224. For example, location sensor(s) 214 can include a GPS receiver that receives data from one or more satellites and allows device 200 to determine the device's absolute position in the world.

Device 200 includes orientation sensor(s) 216 for detecting orientation and/or movement of device 200 and/or display(s) 224. For example, device 200 uses orientation sensor(s) 216 to track changes in the position and/or orientation of device 200 and/or display(s) 224, such as with respect to physical objects in the real environment. Orientation sensor(s) 216 optionally include one or more gyroscopes and/or one or more accelerometers.

Device 200 is not limited to the components and configuration of FIG. 2, but can include other or additional components in multiple configurations.

Attention is now directed towards examples of user interfaces (“UI”) and associated processes that are implemented on an electronic device, such as portable multifunction device 100, device 200, device 300, device 400, device 500, or device 600.

The examples described below provide ways in which an electronic device scans a real-world object, for instance to generate a three-dimensional object of the scanned physical object. The embodiments herein improve the speed and accuracy of object scanning operations, thereby enabling the creation of accurate computer models.

FIG. 3 illustrates exemplary ways in which an electronic device 300 scans real-world objects in accordance with some embodiments of the disclosure. In FIG. 3, device 300 is capturing an image of real-world environment 310 (optionally continuously capturing images of real-world environment 310). In some examples, device 300 is similar to device 100 and/or device 200 described above with respect to FIG. 1 and FIG. 2. In some examples, device 300 includes one or more capture devices (e.g., image sensor(s) 210) and captures an image of the real-world environment 310 using the one or more capture devices. As described above with respect to FIG. 2, the one or more capture devices are hardware components capable of capturing information about real-world objects in a real-world environment. One example of a capture device is a camera (e.g., visible light image sensor) that is able to capture an image of the real-world environment. Another example of a capture device is a time-of-flight sensor (e.g., depth sensor) that is able to capture the distance that certain objects in a real-world environment is from the sensor. In some examples, device 300 uses multiple and/or different types of sensors to determine the three-dimensional shape and/or size of an object (e.g., at least one camera and at least one time-of-flight sensor). In one example, device 300 uses the time-of-flight sensor to determine the shape, size, and/or topography of an object and the camera to determine the visual characteristics of the object (e.g., color, texture, etc.). Using data from both of these capture devices, device 300 is able to determine the size and shape of an object and the look of the object, such as color, texture, etc.

Referring back to FIG. 3, real-world environment 310 includes a table 320 and a vase (e.g., such as vase 130) located at the top of table 320. In some examples, device 300 displays user interface 301. In some examples, user interface 301 is displayed using a display generation component. In some examples, the display generation component is a hardware component (e.g., including electrical components) capable of receiving display data and displaying a user interface. Examples of a display generation component include a touch screen display, a monitor, a television, a projector, an integrated, discrete, or external display device, a wearable device (e.g., such as the head-mountable systems described above), or any other suitable display device. In some examples, display(s) 224 described above with respect to FIG. 2 is a display generation component.

In some examples, user interface 301 is a camera-style user interface that displays a real time view of the real-world environment 310 captured by the one or more sensors of device 300. For example, the one or more sensors capture the vase and a portion of table 320 and thus user interface 301 displays a representation 330 of the vase and a representation of the portion of table 320 that is captured by the one or more sensors (e.g., an XR environment). In some examples, user interface 301 includes reticle 302 that indicates the center position or focus position of the one or more sensors. In some examples, reticle 302 provides the user with a guide and/or target and allows a user to indicate to device 300 what object the user desires to be scanned. As will be described in further detail below, when reticle 302 is placed over a real-world object (e.g., device 300 is positioned such that the one or more sensors are centered on and capture the desired object), device 300 identifies the object of interest separate from other objects in the real-world environment (e.g., using data received from the one or more sensors) and initiates the process of scanning the object.

In some examples, as will be described in further detail below, the process of scanning the object involves performing multiple captures of the respective object from multiple angles and/or perspectives. In some examples, using the data from the multiple captures, device 300 constructs a partial or complete three-dimensional scan of the respective object. In some examples, device 300 processes the three-dimensional scan and generates a three-dimensional model of the object. In some examples, device 300 sends the three-dimensional scan data to a server to generate the three-dimensional model of the object. In some examples, processing the three-dimensional scan and generating a three-dimensional model of the object includes performing one or more photogrammetry processes. In some examples, the three-dimensional model can be used in a XR setting creation application. In some examples, device 300 is able to perform the process of scanning the object without requiring the user to place the object on, in, or next to a particular reference pattern (e.g., a predetermined pattern, such as a hashed pattern) or reference object (e.g., a predetermined object), or at a reference location (e.g., a predetermined location). For example, device 300 is able to identify the object separate from other objects in the environment and scan the object without any external reference.

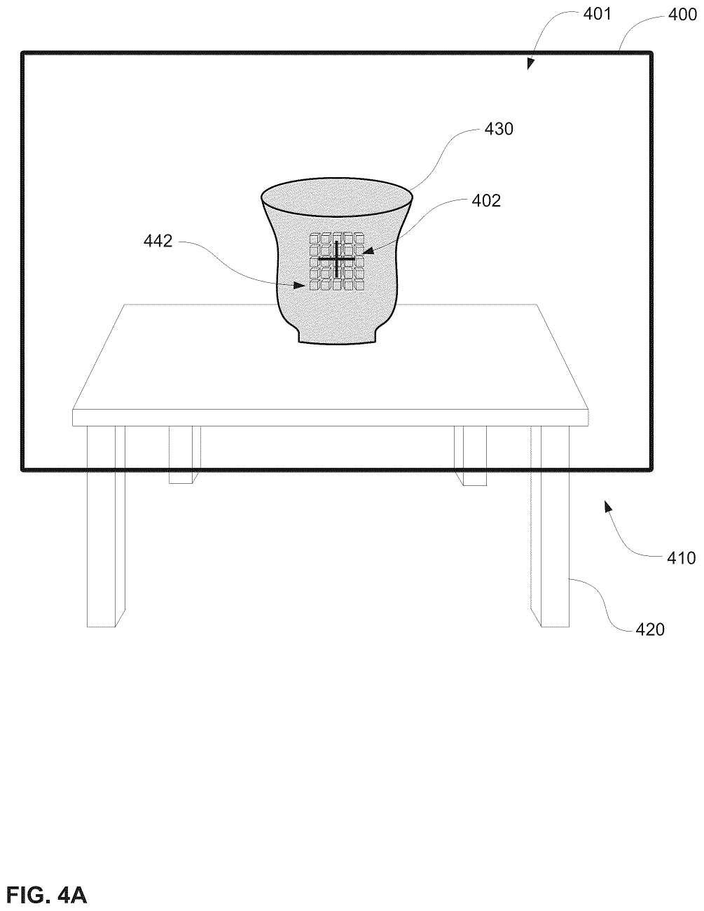

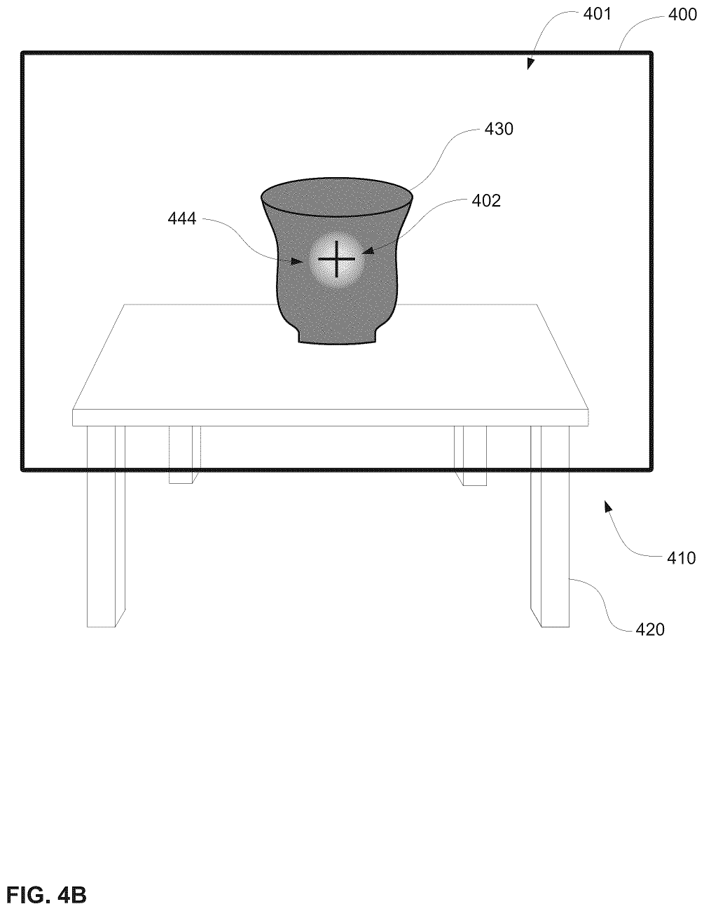

FIGS. 4A-4B illustrate exemplary ways in which an electronic device 400 scans real-world objects and displays an indication of the scan progress in accordance with some examples of the disclosure. In FIG. 4A, device 400 is similar to device 300, device 200, and/or device 100 with respect to FIGS. 1-3. As shown in FIG. 4A, a user has placed reticle 402 on or near an object (e.g., such as shown in FIG. 3). In some examples, in response to determining that the user has placed reticle 402 on or near an object (e.g., within 1 inch, 2 inches, 6 inches, 12 inches, 2 feet, etc.), device 400 identifies the object as the object that the user is intending to scan. For example, in FIG. 4A, reticle 402 has been placed over representation 430 of the vase and device 400 determines that the user is interested in scanning the vase (e.g., intending to scan the vase, requesting to scan the vase, etc.). Thus, device 400 initiates a process for scanning the vase (e.g., for generating a three-dimensional model of the vase). In some examples, the device determines whether the user has placed the reticle over the object for a threshold amount of time (e.g., 0.5 second, 1 second, 2 seconds, 5 seconds, 10 seconds) in determining that the user is requesting to scan the object. In some examples, the request to scan the object includes a user performing a selection input (e.g., a tap) on the representation of the object (e.g., via the touch-screen display). In some examples, as part of determining that the user is wishing to scan the object, device 400 performs image segmentation to determine the boundaries of the object in the overall environment. In some examples, image segmentation includes identifying the object separate from other objects in the physical environment. In some examples, image segmentation is performed using data and/or information acquired from one or more initial captures (e.g., using the one or more capture devices, such as a depth sensor, a visible light sensor, etc., and/or any combination).

In some examples, device 400 performs one or more captures of the vase using the one or more capture devices. In some examples, the one or more capture devices capture a subset of the total environment that is displayed on user interface 401. For example, the one or more capture devices may capture only a small radius at or near the center of the capture devices (e.g., the focal point), such as at or near the location of reticle 402 while user interface 401 displays a larger view of the real-world environment 410. In some examples, the one or more capture devices captures one or more of the color(s), shape, size, texture, depth, topography, etc. of a respective portion of the object. In some examples, while performing directed captures of the object, the one or more capture devices continue to capture the real world environment, for the purpose of display the real world environment in user interface 401, for example.

In some examples, a capture of a portion of the object is accepted if and/or when the capture satisfies one or more capture criteria. For example, the one or more capture criteria includes a requirement that the one or more capture devices be at a particular position with respect to the portion of the object being captured. In some examples, the capture devices must be at certain angles with respect to the portion being captured (e.g., at a “normal” angle, at a perpendicular angle, optionally with a tolerance of 5 degrees, 10 degrees, 15 degrees, 30 degrees, etc. in any direction from the “normal” angle.). In some examples, the capture devices must be more than a certain distance from the portion being captured (e.g., more than 3 inches away, 6 inches away, 12 inches away, 2 feet away, etc.), and/or less than a certain distance from the portion being captured (e.g., less than 6 feet away, 3 feet away, 1 foot away, 6 inches away, etc.). In some examples, the distance(s) at which the captures satisfy the criteria depend on the size of the object. For example, a large object requires scans from further away and a small object requires scans from closer. In some examples, the distance(s) at which the captures satisfy the criteria does not depend on the size of the object (e.g., is the same regardless of the size of the object). In some examples, the one or more capture criteria includes a requirement that the camera be held at the particular position for more than a threshold amount of time (e.g., 0.5 seconds, 1 second, 2 seconds).

In some examples, the one or more capture criteria include a requirement that the portion of the object captured by the capture overlaps with portions of the object captured by previous captures by a threshold amount (e.g., 10% of the new capture overlaps with previous captures, 25% overlap, 30% overlap, 50% overlap, etc.). In some examples, if a new capture does not overlap with a previous capture by the threshold amount, the one or more capture criteria are not satisfied. In some examples, overlapping the captures allows device 400 (or optionally a server that generates the three-dimensional model) to align the new capture with previous captures.

In some examples, captures of a portion of the object that satisfy the one or more capture criteria are accepted by device 400. In some examples, captures of a portion of the object that do not satisfy the one or more criteria are rejected by device 400 and a user may be required to perform another capture of the portion of the object (e.g., an indication or prompt may be displayed on the user interface, or the interface does not display an indication that the capture was successful). In some examples, captures that are accepted by device 400 are saved and/or merged with previous captures of the object. In some examples, captures that do not satisfy the one or more capture criteria are discarded (e.g., not served and not merged with previous captures of the object). In some examples, if the one or more capture criteria is not satisfied, user interface 401 can display one or more indications to instruct and/or guide the user. For example, user interface 401 can display a textual indication instructing the user to slow down, move closer, move further, move to a new location, etc.

Referring back to FIG. 4A, device 400 displays user interface 401, which includes a representation 430 of vase and a representation of a portion of table 420. In some examples, in response to successfully performing a capture of a portion of an object (e.g., one which satisfies the one or more capture criteria such that the capture is accepted), device 400 displays, on user interface 401, an indication of the object scanning progress on the representation of the object. For example, in FIG. 4A, the indication of the object scanning progress includes displaying one or more objects on the portion of the representation 430 of the object corresponding to the portion of vase that was successfully captured. In some examples, the objects are two-dimensional objects and/or three-dimensional objects. In some examples, the objects are voxels, cubes, pixels, etc. In some examples, the objects are points (e.g., dots). In some examples, the objects representative of a captured portion are quantized (e.g., lower-resolution) versions of an otherwise photorealistic (e.g., higher-resolution) display of the object. For example, the objects can have one or more visual characteristics of the respective portion of the object, such as having the same color as the respective portion (optionally the average color of the entire respective portion).

FIG. 4A illustrates device 400 displaying a first set of voxels 442 corresponding to the portion of the vase that was captured during the first capture of the vase. As shown in FIG. 4A, the first set of voxels 442 is displayed on the representation 430 of the vase at the portion of the vase that was captured. In some examples, displaying the indication of the capture progress on the representation of the object itself allows the user to receive feedback that the capture was successful and accepted and visually identifies the portions of the object that have been captured and the portions of the object that have not yet been captured.

In some examples, as the user moves around the vase and/or changes angles and/or positions with respect to vase (and user interface 401 is updated to show different angles or portions of the vase due to device 400 moving to different positions and angles), device 400 continually performs additional captures of the vase (e.g., every 0.25 seconds, 0.5 seconds, every 1 second, every 5 seconds, every 10 seconds, every 30 seconds, etc.). In some examples, additional captures are performed in response to detecting that the device has moved to a new position, that the device position has stabilized (e.g., has moved less than a threshold for more than a time threshold), and/or that the device is able to capture a new portion of the object (e.g., has less than a threshold amount of overlap with a previous capture), etc. In some examples, in response to the additional captures of the vase and in accordance with a determination that the additional captures satisfy the one or more capture criteria (e.g., with respect to uncaptured portions of the vase), device 400 displays additional sets of voxels corresponding to the portions of the vase that were captured by the additional captures. For example, for each capture, device 400 determines whether the capture satisfies the capture criteria and if so, the capture is accepted.

For example, a user may move device 400 such that reticle 402 is positioned over a second portion of vase (e.g., a portion that was not fully captured by the first capture). In response to determining that the user has moved device 400 such that reticle 402 is over the second portion of the vase (e.g., in response to determining that reticle 402 is over the second portion of the vase), device 400 performs a capture of the second portion of the vase. In some examples, if the second capture satisfies the one or more capture criteria, then the second capture is accepted and device 400 displays a second set of voxels on representation 430 of the vase corresponding to the second portion of vase that was captured.

As described above, in some examples, device 400 performs captures of the object in response to determining that device 400 is positioned over an uncaptured portion of the object (e.g., a not fully captured portion of the object or a partially captured portion of the object). In some examples, device 400 performs continuous captures of the object (e.g., even if the user has not moved device 400) and accepts captures that satisfy the one or more capture criteria (e.g., position, angle, distance, etc.).

FIG. 4B illustrates an alternative example of displaying an indication of the object scanning progress on the representation of the object being scanned. As shown in FIG. 4B, in response to successfully performing a capture of a portion of an object (e.g., one which satisfies the one or more capture criteria such that the capture is accepted), device 400 displays, on user interface 401, an indication of the object scanning progress on the representation of the object. In FIG. 4A, the indication of the object scanning progress includes changing the one or more visual characteristics of the portion of the representation 430 of the object corresponding to the portion of vase that was successfully captured. In some examples, changing the visual characteristic includes changing a color, hue, brightness, shading, saturation, etc. of the portion of the representation of the object.

In some examples, when device 400 determines that the user is interested in scanning the vase (e.g., such as after the techniques discussed with reference to FIG. 3), representation 430 of the vase is displayed with a modified visual characteristic. As shown in FIG. 4B, device 400 darkens representation 430 of the vase (e.g., to a color darker than the originally captured color). In some examples, when portions of the vase are captured, the captured portions are modified to display the original unmodified visual characteristic. For example, as shown in FIG. 4B, portion 444 of representation 430 that has been captured has been updated to be brighter. In some examples, the updated brightness is the original unmodified brightness of portion 444 of the representation. In this way, as device 400 captures more portions of the vase, representation 430 appears as if it is revealing portions of the vase.

In some examples, when device 400 determines that the user is interested in scanning the vase, representation 430 of the vase is displayed without modifying (e.g., darkening) representation 430 of the vase. In such examples, as device 400 performs successful captures of the vase, the portion of representation 430 corresponding to the captured portions of the vase are modified to have a different visual characteristic than the original unmodified representation of the vase (e.g., displayed darker, lighter, with a different color, etc.).

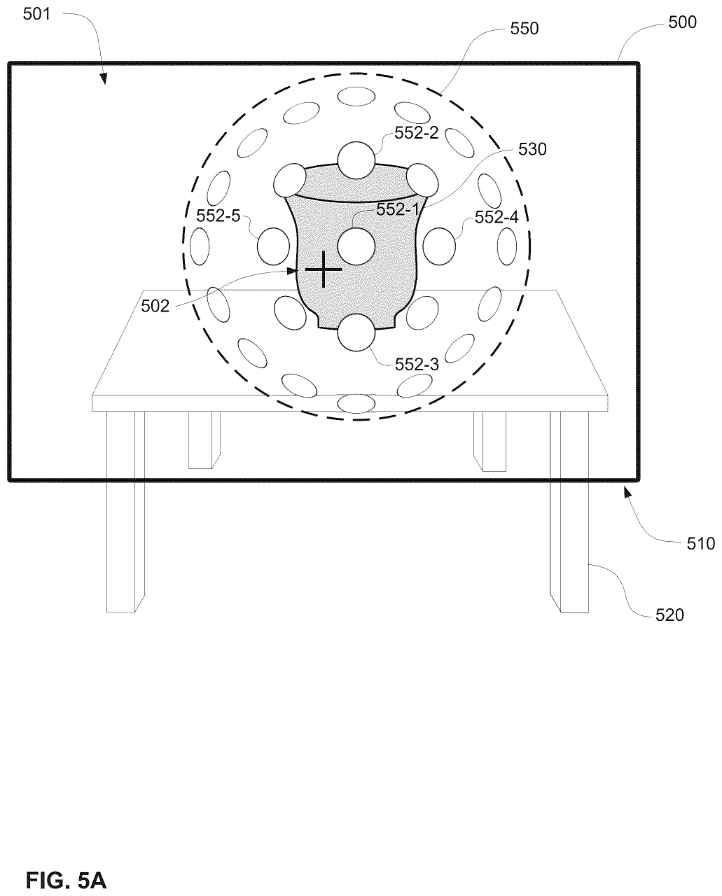

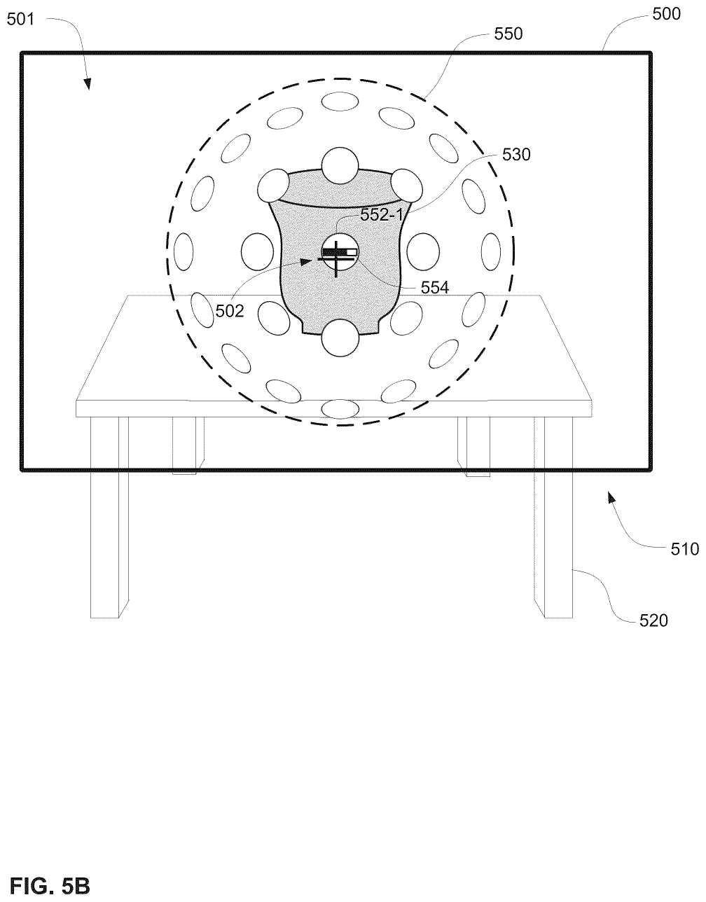

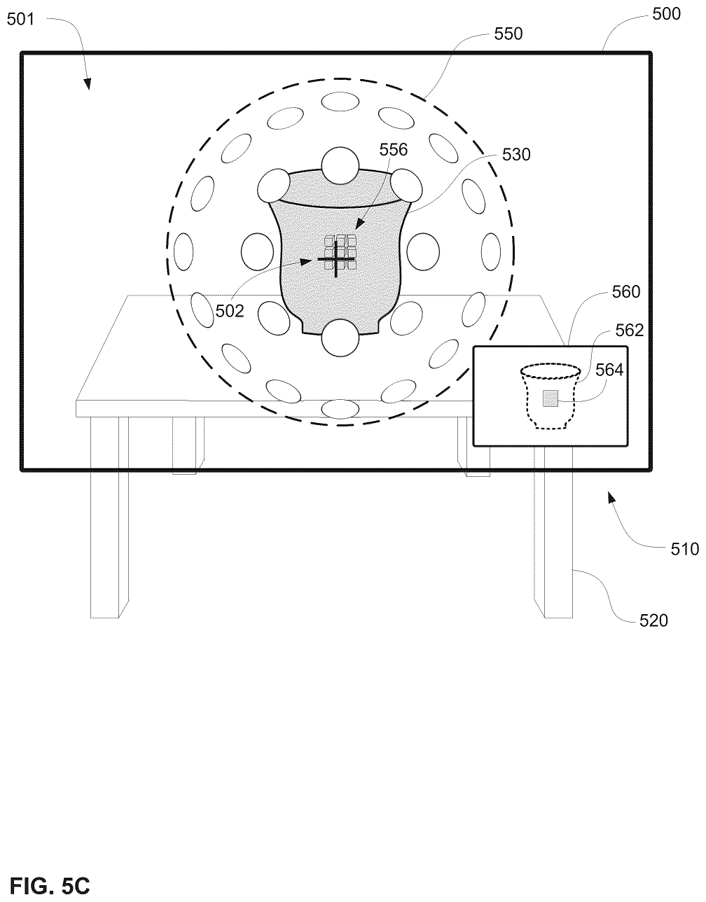

FIGS. 5A-5C illustrate exemplary ways in which an electronic device 500 displays targets (e.g., capture targets) for scanning real-world objects in accordance with some examples of the disclosure. In some examples, device 500 is similar to device 100, device 200, device 300, and/or device 400 described above with respect to FIG. 1-4. In FIG. 5A, device 500 displays user interface 501. In some examples, when device 500 determines that the user is interested in scanning the vase (e.g., such as after a user has placed the reticle on or near the object, shown in FIG. 3), device 500 determines (e.g., generates, identifies, etc.) a shape 550 around the vase (e.g., a bounding volume). In some examples, the generation of shape 550 is based on an initial determination of the shape and/or size of the vase. In some examples, when device 500 determines that the user is interested in scanning the vase, device 500 performs one or more initial captures to determine a rough shape and/or size of the vase. In some examples, the initial capture is performed using a depth sensor. In some examples, the initial capture is performed using both a depth sensor and a visual light image sensor (e.g., camera). In some examples, using the initial capture, device 500 determines the shape and/or size of the vase. Once determined, shape 550 can act as a bounding volume that bounds the object to be captured.

In some examples, shape 550 is not displayed in user interface 501 (e.g., exists only in software and is displayed in FIG. 5A for illustrative purposes). In some examples, shape 550 is a three-dimensional shape around representation 530 of the vase (e.g., representation 530 is at the center of shape 550 in all three dimensions). As shown in FIG. 5A, shape 550 is a sphere. In some examples, shape 550 is a three-dimensional rectangle, a cube, a cylinder, etc. In some examples, the size and/or shape of shape 550 depends on the size and/or shape of the object being captured. For example, if the object is generally cylindrical, shape 550 may be cylindrical to match the general shape of the object. On the other hand, if the object is rectangular, shape 550 may be a cube. If the object does not have a well-defined shape, then shape 550 may be spherical. In some examples, the size of shape 550 may depend on the size of the object being captured. In some examples, if the object is large, then shape 550 is large and if the object is small, then shape 550 is small. In some examples, shape 550 generally has a size such that the distance between the surface of shape 550 and the surface of the object being scanned is within a certain distance window (e.g., greater than 3 inches, 6 inches, 1 foot, 2 feet, 5 feet, and/or less than 1 foot, 2 feet, 4 feet, 10 feet, 20 feet, etc.). In some examples, a user is able to resize or otherwise modify shape 550 (e.g., by dragging and/or dropping a corner, edge, a point on the surface, and/or a point on a boundary of the shape).

In some examples, targets 552 (e.g., targets 522-1 to 552-5) are displayed in user interface 501 around representation 530 of the vase. In some examples, targets 552 are placed on the surface of shape 550 such that targets 552 are floating in three-dimensional space around representation 530 of the vase. In some examples, each of the targets are discrete visual elements placed at discrete locations around representation 530 of the vase (e.g., the elements are not contiguous and do not touch each other). In some examples, targets 552 are circular. In some examples, targets 552 can be any other shape (e.g., rectangular, square, triangular, oval, etc.). In some examples, targets 552 are angled to be facing representation 530 of the vase (e.g., each of the targets 552 are at a normal angle to the center of representation 530 of the vase). As shown in FIG. 5A, target 552-1 is circular and is facing directly toward the center of representation 530 in three-dimensional space such that it appears to be facing inwards (e.g., away from device 500) and target 552-4 is facing directly toward the center of representation 530 in three-dimensional space such that it appears to be facing diagonally inwards and toward the left. Thus, the shape and direction of the targets provide the user an indication of where and how to position device 500 to capture not-yet-captured portions of the vase. For example, each target corresponds to a respective portion of the vase such that when device 500 is aligned with a respective target (e.g., when reticle 502 is placed on the target), its corresponding portion of the vase is captured. In some examples, each target is positioned such that when device 500 is aligned with a respective target (e.g., when reticle 502 is placed on the target), one or more of the one or more capture criteria are satisfied. For example, the distance between each target and the object is within the acceptable distance range, the angle that the target is facing with respect to the object is within the acceptable angle range, and the distance between each target is within the acceptable distance (e.g., has a satisfactory amount of overlap with captures associated with adjacent target). In some examples, not all of the one or more capture criteria are automatically satisfied when the reticle 502 is placed on the target. For example, the camera must still be held aligned with the target for more than a threshold amount of time. In some examples, as device 500 moves around the vase, the targets remain at the same position in three-dimensional space, allowing the user to align reticle 502 with the targets as the user moves device 500 around the vase.

Referring back to FIG. 5A, device 500 is positioned such that reticle 502 is not aligned with any of the targets. Thus, as shown in FIG. 5A, no captures of the vase have been taken and/or accepted.

In FIG. 5B, the user has moved device 500 such that reticle 502 is now at least partially aligned with target 552-1. In some examples, in response to reticle 502 being at least partially aligned with target 552-1, device 500 initiates the process for capturing the portion of the vase corresponding to target 552-1. In some examples, device 500 initiates the process of capturing the portion of the vase when reticle 502 is completely aligned with target 552-1 (e.g., entirely within target 552-1). In some examples, device 500 initiates the process of capturing the portion of the vase when reticle 502 overlaps with target 552-1 by a threshold amount (e.g., 30%, 50%, 75%, 90%, etc.). In some examples, reticle 502 is at least partially aligned with target 552-1 when the angle of device 500 is aligned with the angle of target 552-1 (e.g., at a normal angle with target 552-1 plus or minus a tolerance of 5 degrees, 10 degrees, 20 degrees, etc.).

In some examples, as shown in FIG. 5B, while device 500 is performing the capture, progress indicator 554 is displayed on target 552-1. In some examples, progress indicator 554 is a rectangular progress bar. In some examples, progress indicator 554 is a circular progress bar. In some examples, progress indicator 554 is an arcuate progress bar. In some examples, additionally or alternatively to displaying progress indicator 554, target 552-1 changes one or more visual characteristics to indicate the capture progress. For example, target 552-1 can change colors while the capture is occurring. In some examples, the process for capturing the portion of the vase includes taking a high definition capture, a high-resolution capture, and/or multiple captures that are merged into one capture. In some examples, the process for capturing the portion of the vase requires the user to hold the device still for a certain amount of time and progress indicator 554 provides the user an indication of how long to continue holding the device still and when the capture has completed. In some examples, if device 500 is moved such that reticle 502 is no longer partially aligned with target 552-1, the process for capturing the portion of the vase is terminated. In some examples, the data captured so far is saved (e.g., such that if the user were to move the device to re-align with target 552-1, the user does not need to wait for the full capture duration). In some examples, the data captured so far is discarded (e.g., such that if the user were to move the device to re-align with target 552-1, the user would need to wait for the full capture duration).

In some examples, after the capture has successfully completed, target 552-1 ceases to be displayed in user interface 501, as shown in FIG. 5C. In some examples, device 500 displays a set of voxels 556 on the representation 530 of the vase at the portion of vase that was captured. It is understood that any of the indications of scan progress discussed with respect to FIGS. 4A-4B can be displayed (e.g., displaying voxels or changing a visual characteristic). In some examples, no indications of scan progress are displayed on the representation 530 of the vase and the scan progress is indicated by the removal of target 522-1 (e.g., when all targets have ceased to be displayed, the entirety of the process for capturing the object is completed).

Thus, as described above, in some examples, only captures that are taken when reticle 502 is aligned (or partially aligned) with a target are accepted and saved (e.g., optionally only if the capture satisfies the one or more capture criteria described above when reticle 502 is aligned with a target).

In some examples, as shown in FIG. 5C, device 500 displays a preview 560 of the captured object. In some examples, preview 560 includes a three-dimensional render of the captured object from the same perspective as what is currently being captured by the one or more capture devices. For example, if device 500 is facing the front of the object being captured, then preview 560 displays the front of the object being captured. Thus, as the user moves around the vase to capture different portions of the vase, preview 560 will also rotate and/or turn the preview of the vase accordingly.

In some examples, preview 560 is scaled such that the object being scanned fits entirely within preview 560. For example, as shown in FIG. 5C, the entirety of vase 562 fits within preview 560. In some examples, preview 560 includes a representation of vase 562. In some examples, a representation of vase 562 is not displayed and is included in FIG. 5C for illustrative purposes (e.g., to show the scale of the renders). Thus, preview 560 provides the user with an overall preview of the captured object as it is being captured (e.g., as opposed to the live display of the real-world environment 510 that is displayed in the main portion of user interface 501, which may display only a portion of the object being captured).

In FIG. 5C, preview 560 displays capture 564 corresponding to the portions of the vase that have been captured so far. In some examples, capture 564 is scaled based on the size of vase 562. For example, if the size of the object being scanned is large, capture 564 may be displayed with a small size because the first capture may capture a small proportion of the object. On the other hand, if the size of the object being scanned is small, capture 564 may be displayed with a large size because the first capture may capture a large proportion of the object.

In some examples, capture 564 has the same or similar visual characteristics as the portions of the vase that have been captured and/or as has the same or similar visual characteristics as how the final three-dimensional model will look. For example, instead of displaying a set of voxels or displaying the vase as darker or lighter than the capture (e.g., such as in the main portion of user interface 501), capture 564 displays a rendering of the actual capture of the object, including the color(s), shape, size, texture, depth, and/or topography, etc. of the three-dimensional model of the vase to be generated. In some examples, as additional captures are taken and accepted, capture 564 is updated to include the new captures (e.g., expands to include the additional captures).

It is understood that, in some examples, preview 560 can be displayed in any user interface for capturing an object, such as user interface 301 and/or 401. In some examples, preview 560 is not displayed in the user interface before, during, or after capturing an object.

Returning to FIG. 5C, in some examples, if device 500 determines that a particular capture, such as a capture at target 552-1, does not satisfy the one or more capture criteria, target 552-1 remains displayed, indicating to the user that another capture attempt at target 552-1 is required. In some examples, the one or more capture criteria is satisfied and target 552-1 is removed from display, but device 500 determines that one or more additional captures are required (e.g., captures that are in addition to those that would be captured at the currently displayed targets or have been captured so far). For example, a capture at the location of target 552-1 may reveal that the respective portion of the object has a particular texture, topography, or detail that requires additional captures to fully capture. In such examples, in response to determining that additional captures are required, device 500 displays one or more additional targets around the object. In some examples, captures at the one or more additional targets allow device 500 to capture the additional detail that device 500 determined is necessary and/or useful. In some examples, the one or more additional targets can be at locations on the surface of the bounding volume that do not or did not previous display a target (for example, to capture different perspectives). In some examples, the one or more additional targets can be at locations inside or outside of the surface of the bounding volume (for example, to capture a closer or farther image). In some examples, the additional targets need not be at a normal angle to the center of the representation of the object. For example, one or more of the additional targets can be at angles for capturing occluded portions or portions that cannot be properly captured at a normal angle. Thus, in some examples, as the user performs captures, device 500 can dynamically add one or more additional targets anywhere around the representation of the object being captured. Similarly, in some examples, device 500 can dynamically remove one or more of the targets from display if device 500 determines that the particular capture associated with certain targets is unnecessary (e.g., because other captures have sufficiently captured the portions associated with the removed target, and optionally not as a result of performing a successful capture associated with the removed target).

For similar reasons, in some examples, when device 500 determines that the user is interested in scanning the vase, device 500 can determine, based on the initial capture of the vase, that certain portions of the object require additional captures (e.g., in addition to the regularly spaced targets that are displayed on the surface of a bounding volume). In some examples, in response to determining that additional captures are required, device 500 can place one or more additional targets on the surface of the bounding volume or inside or outside of the surface of the bounding volume. Thus, in this way, device 500 can determine, at the outset, that additional targets are required, and display them in the user interface at the appropriate positions and/or angles around the representation of the object. It is understood that, in this example, the device is also able to dynamically place additional targets as necessary while the user is performing captures of the object.

It is understood that the process described above can be repeated and/or performed multiple times, as necessary, to fully capture the object. For example, after performing a partial (e.g., capturing a subset of all the targets) or full capture of the object (e.g., capturing all of the targets), based on information captured, device 500 can determine (e.g., generate, identify, etc.) a new or additional bounding volume around the representation of the object and place new targets on the new or additional bounding volume. In this way, device 500 is able to indicate to the user that another pass is required to fully capture the details of the object.

In some examples, a user is able to prematurely end the capture process (e.g., before capturing all of the targets). In such an example, device 500 can discard the captures and terminate the process for generating the three-dimensional model. For example, if a threshold number of captures have not been captured (e.g., less than 50% captured, less than 75% captured, less than 90% captured, etc.), it may not be possible to generate a satisfactory three-dimensional model, and device 500 can terminate the process for generating the three-dimensional model. In some examples, device 500 can preserve the captures that have been captured so far and attempt to generate a three-dimensional model using the data captured so far. In such examples, the resulting three-dimensional model may have a lower resolution or may have a lower level of detail, than otherwise would be achieved by a full capture. In some examples, the resulting three-dimensional model may be missing certain surfaces that have not been captured.

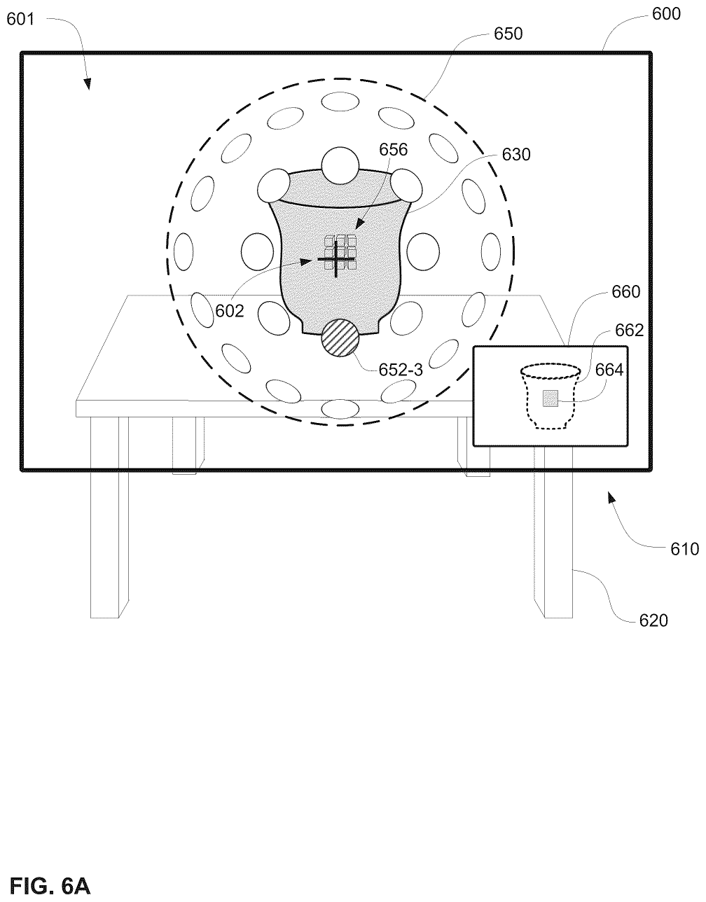

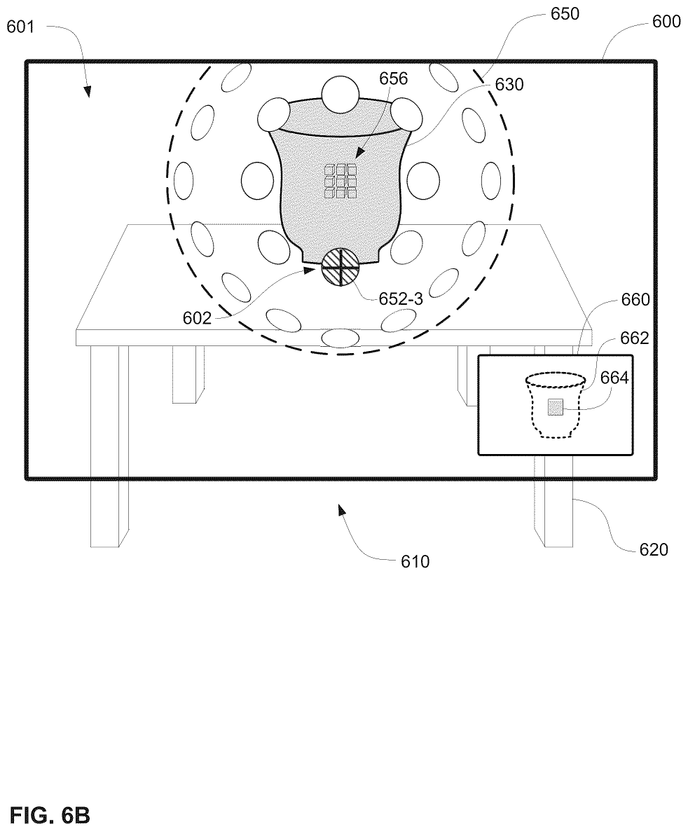

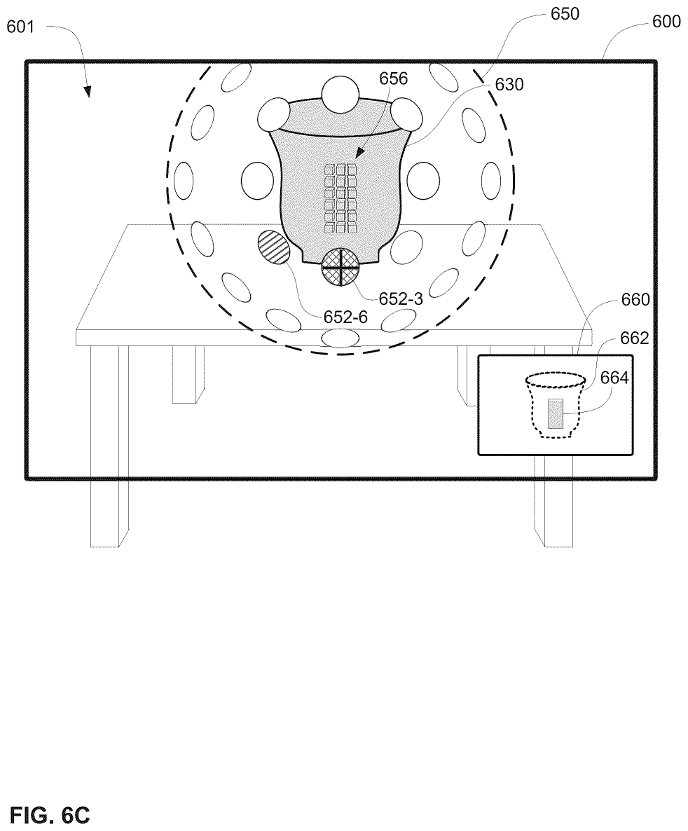

FIGS. 6A-6C illustrate exemplary ways in which an electronic device 600 displays targets for scanning real-world objects in accordance with some examples of the disclosure. In some examples, device 600 is similar to device 100, device 200, device 300, device 400, and/or device 500 described above with respect to FIGS. 1-5. FIG. 6A illustrates an example of device 600 after a first capture has been taken and accepted (e.g., after the capture process illustrated in FIGS. 5A-5C). In some examples, as shown in FIG. 6A, targets that have been successfully captured are removed from display (e.g., target 552-1 as shown in FIG. 5A-5B).

In FIG. 6A, after performing a successful capture associated with a particular target and/or in response to performing a successful capture associated with a particular target, device 500 determines a suggested target for capture. In some examples, the suggested target for capture is the target that is closest to the reticle 602. In some examples, the suggested target for capture is the target that requires the least amount of movement to align the device. In some examples, the suggested target for capture is the target is the next nearest target to the target that was just captured. In some examples, if all remaining targets are the same distance from reticle 602 and/or the target that was just captured, then the suggested target is randomly selected from the nearest targets. In some examples, the suggested target can be selected based on other selection criteria such as the topography of the object, the shape of the object, the position of previous captures (e.g., the suggested target can be selected to allow the user to continue moving in the same direction). In some examples, as the user moves device 600 around, the suggested target can change. For example, if the user moves device 600 such that reticle 602 is now closer to a target other than the suggested target, then device 600 can select a new suggested target, which is closer to the new position of reticle 602.

In some examples, device 600 changes a visual characteristic of the suggested target for capture to visually highlight and differentiate the suggested target from the other targets. In some examples, changing a visual characteristic includes changing one or more of color, shading, brightness, pattern, size and/or shape. For example, the suggested target can be displayed with a different color (e.g., the target can be filled with a particular color, or the border of the target can be changed to a particular color). In the example illustrated in FIG. 6A, target 652-3 is the suggested target (e.g., because it is the target closest to reticle 602) and is updated to include a diagonal pattern. In some examples, all other targets that have not been selected as the suggested target maintain their visual characteristics. In some examples, if device 600 changes the suggested target from one target to another (e.g., as a result of the user moving reticle 602 closer to another target), device 600 reverts the visual characteristic of the first target to the default visual characteristic and changes the visual characteristic of the new suggested target.

FIG. 6B illustrates user interface 601 after the user moves device 600 to align reticle 602 with target 652-3. As shown in FIG. 6B and described above, device 600 maintains the position of each of the targets in three-dimensional space around representation 630 of the vase. Thus, as shown in FIG. 6B, some targets are no longer displayed because they are at a position in three-dimensional space that is not currently being displayed in user interface 601.

In FIG. 6B, in response to the user aligning reticle 602 with target 652-3 (e.g., including aligning the position and angle of device 500), device 600 changes a visual characteristic of target 652-3 to indicate that the user has properly aligned with target 652-3 and that the process for capturing the portion of the vase associated with target 652-3 has been initiated. In some examples, the visual characteristic that is changed is the same visual characteristic that was changed when target 652-3 was selected as the suggested target. For example, if device 600 changed the color of target 652-3 when target 652-3 was selected as the suggested target, then device 600 changes the color of target 652-3 to a different color when the user aligns reticle 602 with target 652-3 (e.g., a color different from the original color of the target and different from the color of target 652-3 when it was selected as the suggested target but before the user has aligned the device with it). As shown in FIG. 6B, target 652-3 is now displayed with a different diagonal pattern than target 652-3 shown in FIG. 6A (e.g., diagonal in a different direction).

FIG. 6C illustrates user interface 601 after the user has successfully captured the portion of the vase corresponding to target 652-3. As shown in FIG. 6C, in response to successfully capturing the portion of the vase corresponding to target 652-3, representation 630 includes voxels at the location on representation 630 corresponding to the portion that was captured. As shown in FIG. 6C, in response to successfully capturing the portion of the vase corresponding to target 652-3, preview 660 is updated such that capture 664 displays the portion of the vase that was captured. In some examples, as described above, the perspective and/or angle of preview 660 changes as the device changes perspective and/or angle, but the scale and/or position of the representation of the captured object in preview 660 does not change and the representation of the captured object remains centered in preview 660 (e.g., is not moved upwards even though representation 630 of the vase is moved upwards as a result of device 600 moving downwards in three-dimensional space).

In some examples, as shown in FIG. 6C, device 600 changes the visual characteristic of target 652-3 to having a third visual characteristic. In some examples, the visual characteristic that is changed is the same visual characteristic that was changed in FIGS. 6A-6B. For example, if device 600 changed the color of target 652-3 when target 652-3 was selected as the suggested target and/or when the user aligned reticle 602 with target 652-3, then device 600 can change the color of target 652-3 to a third color when the capture is successful. In the example illustrated in FIG. 6C, target 652-3 is now displayed with a hashed pattern. In some example, changing the visual characteristic of target 652-3 can include ceasing display of target 652-3 (e.g., such as illustrated in FIG. 5C with respect to target 552-1).

As shown in FIG. 6C, in response to successfully capturing the portion of the vase corresponding to target 652-3, device 600 selects the next suggested target (e.g., target 652-6) and changes the visual characteristic of the next suggested target as described above with respect to FIG. 6A.

In some examples, a user is able to physically change the orientation of the object being scanned (e.g., the vase) and device 600 is able to detect the change in orientation and adjust accordingly. For example, a user is able to turn the vase upside down such that the bottom of the vase is facing upwards (e.g., revealing a portion of the vase that was previously not capture-able). In some examples, device 600 is able to determine that the orientation of the vase has changed and in particular, that the bottom of the vase is now facing upwards. In some examples, in response to this determination, preview 660 is updated such that captures 664 are displayed upside down, thus providing the user a visualization of areas that haven't been captured (e.g., namely the bottom of the vase). In some examples, because the main portion of user interface 601 is displaying a live view of the real-world environment, representation 630 is also displayed upside down. In some examples, the indications of capture progress (e.g., the voxels) are displayed in the appropriate position on representation 630 (e.g., are also displayed upside down). In another example, the user is able to turn the vase sideways, and preview 660 is updated such that capture 664 is sideways and representation 630 and its accompanying voxels are also displayed sideways. Thus, in some examples, a user is able to walk around an object and scan the object from different angles, and then turn the object to scan areas that were hidden, such as the bottom. Alternative, the user can stay within a relatively small area, and continue to physically rotate the object to scan portions of the object that were hidden (e.g., the back side/far side of the object). In some examples, the targets displayed around representation 630 also rotate, move, or otherwise adjust based on the determined change in orientation.

It is understood that although FIGS. 5A-5B and FIGS. 6A-6C illustrate the display of voxels to indicate the scan progress, device 500 and/or device 600 can implement the process described in FIG. 4B (e.g., changing a visual characteristic of the representation). In some examples, device 500 and/or device 600 does not display an indication of progress on the representation itself and, the existence and/or changing visual characteristics of the targets indicates the scan progress (e.g., if targets are displayed, then full capture is not completed and if no targets are displayed, then the object is fully captured). It is also understood that the preview illustrated in FIG. 5C and FIGS. 6A-6C is optional and can be not displayed in the user interface. Alternatively, the preview illustrated in FIG. 5C and FIGS. 6A-6C can be displayed in the user interfaces in FIGS. 4A-4B. It is also understood that any of the features described herein can be combined or can be interchangeable without departing from the scope of this disclosure (e.g., the display of targets, the display of voxels, changing characteristics, and/or the display of the preview).

In some examples, the process for scanning/capturing a real-world object to generate a three-dimensional model of the object is initiated in response to a request to insert a virtual object in an extended reality (XR) setting. For example, an electronic device (e.g., device 100, 200, 300, 400, 500, 600) can execute and/or display an XR setting creation application. While manipulating, generating, and/or modifying a XR setting (e.g., a CGR environment) in the XR setting creation application, a user may desire to insert an object for which a three-dimensional object model does not exist. In some examples, a user is able to request the insertion of said object and in response to the request, the device initiates a process to scan/capture the appropriate real-world object and displays a user interface for scanning/capturing the real-world object (e.g., such as user interface 301, 401, 501, 601 described above). In some examples, after completing the process for scanning/capturing the real-world object, a placeholder model (e.g., temporary model) can be generated and inserted into the XR setting using the XR setting creation application. In some examples, the placeholder model is based on the general size and shape of the object captured during the capture process. In some examples, the placeholder model is the same or similar to the preview discussed above with respect to FIGS. 5C and 6A-6C. In some examples, the placeholder model only displays a subset of the visual details of the object. For example, the placeholder model may be displayed with only one color (e.g., a grey or plain color), without any textures, and/or at a lower resolution, etc.

In some examples, after the process for capturing the object is complete, the capture data is processed to generate the complete three-dimensional model. In some examples, processing the data includes transmitting the data to a server and the generation of the model is performed at the server. In some examples, when the three-dimensional object model of the object is completed (e.g., by the device or by the server), the XR setting creation application automatically replaces the placeholder object with the completed three-dimensional model of the object. In some examples, the completed three-dimensional model includes the visual details that were missing in the placeholder model, such as the color and/or textures. In some examples, the completed three-dimensional model is a higher resolution object than the placeholder object.

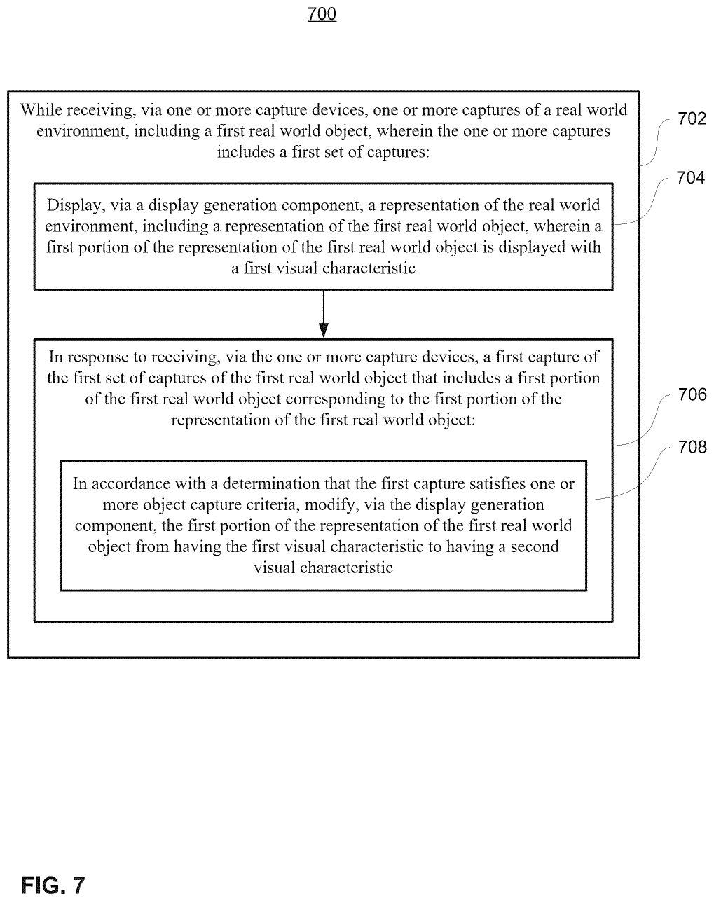

FIG. 7 is a flow diagram illustrating a method 700 of scanning a real-world object in accordance with some embodiments of the disclosure. The method 700 is optionally performed at an electronic device such as device 100, device 200, device 300, device 400, device 500, and device 600 when performing object scanning described above with reference to FIGS. 1, 2-3, 4A-4B, 5A-5C, and 6A-6C. Some operations in method 700 are, optionally combined and/or order of some operations is, optionally, changed.

As described below, the method 700 provides methods of scanning a real-world object in accordance with some embodiments of the disclosure (e.g., as discussed above with respect to FIGS. 3-6).

In some examples, an electronic device in communication with a display (e.g., a display generation component, a display integrated with the electronic device (optionally a touch screen display), and/or an external display such as a monitor, projector, television, etc.) and one or more cameras (e.g., a mobile device (e.g., a tablet, a smartphone, a media player, or a wearable device), or a computer, optionally in communication with one or more of a visible light camera, a depth camera, a depth sensor, an infrared camera, and/or a capture device, etc.), while receiving, via the one or more cameras, one or more captures of a real world environment, including a first real world object, wherein the one or more captures includes a first set of captures (702): displays (704), using the display, a representation of the real world environment, including a representation of the first real world object, wherein a first portion of the representation of the first real world object is displayed with a first visual characteristic; and in response to receiving, via the one or more cameras, a first capture of the first set of captures of the first real world object that includes a first portion of the first real world object corresponding to the first portion of the representation of the first real world object (706), in accordance with a determination that the first capture satisfies one or more object capture criteria, updates the representation of the first real world object to indicate a scanning progress of the first real world object, including modifying (708), using the display, the first portion of the representation of the first real world object from having the first visual characteristic to having a second visual characteristic.

Additionally or alternatively, in some examples, the one or more cameras includes a visual light camera. Additionally or alternatively, in some examples, the one or more cameras includes a depth sensor. Additionally or alternatively, in some examples, modifying the first portion of the representation of the first real world object from having the first visual characteristic to having the second visual characteristic includes changing a shading of the first portion of the representation of the first real world object. Additionally or alternatively, in some examples, modifying the first portion of the representation of the first real world object from having the first visual characteristic to having the second visual characteristic includes changing a color of the first portion of the representation of the first real world object.

Additionally or alternatively, in some examples, the electronic device receives, via the one or more cameras, a second capture of the first set of captures of the first real world object that includes a second portion of the first real world object, different from the first portion. Additionally or alternatively, in some examples, in response to receiving the second capture and in accordance with a determination that the second capture satisfies the one or more object capture criteria, the electronic device modifies, using the display, a second portion of the representation of the first real world object corresponding to the second portion of the first real world object from having a third visual characteristic to having a fourth visual characteristic.

Additionally or alternatively, in some examples, the one or more object capture criteria include a requirement that a respective capture is within a first predetermined range of angles relative to a respective portion of the first real world object. Additionally or alternative, in some examples, the one or more object capture criteria includes a requirement that the capture is within a first predetermined range of distances. Additionally or alternative, in some examples, the one or more object capture criteria includes a requirement that the capture is held for a threshold amount of time. Additionally or alternative, in some examples, the one or more object capture criteria includes a requirement that the capture is not of a portion that has already been captured. Additionally or alternative, in some examples, determining whether the one or more object capture criteria is satisfied can be performed using data that is captured by the one or more cameras (e.g., by analyzing the images and/or data to determine whether it satisfies the criteria and/or has an acceptable level quality, detail, information, etc.).

Additionally or alternatively, in some examples, in response to receiving the first capture of the first portion of the first real world object and in accordance with a determination that the first capture does not satisfy the one or more object capture criteria, the electronic device forgoes modifying the first portion of the representation of the first real world object. Additionally or alternatively, in some examples, the electronic device discards the data corresponding to the first capture if the first capture does not satisfy the one or more object capture criteria.

Additionally or alternatively, in some examples, while receiving the one or more captures of the real world environment, the electronic device displays using the display, a preview of a model of the first real world object, including captured portions of the first real world object. Additionally or alternatively, in some examples, the preview of the model does not include uncaptured portions of the first real world object.

Additionally or alternatively, in some examples, while displaying the preview of the model of the first real world object, the electronic device detects a change in an orientation of the first real world object. Additionally or alternatively, in some examples, in response to detecting the change in the orientation of the first real world object, the electronic device updates the preview of the model of the first real world object based on the change in orientation of the first real world object, including revealing uncaptured portions of the first real world object and maintaining display of captured portions of the first real world object.

Additionally or alternatively, in some examples, the one or more captures includes a second set of captures, before the first set of captures. Additionally or alternatively, in some examples, the electronic device receives, via the one or more cameras, a first capture of the second set of captures of the real world environment, including the first real world object. Additionally or alternatively, in some examples, in response to receiving the first capture of the second set of captures, the electronic device identifies the first real world object in the real world environment, separate from other objects in the real world environment, and determines a shape and size of the first real world object.

Additionally or alternatively, in some examples, the first capture of the second set of captures is received via a capture device of a first type (e.g., a depth sensor). Additionally or alternatively, in some examples, the first capture of the first set of captures is received via a capture device of a second type, different from the first type (e.g., a visible light camera).

Additionally or alternatively, in some examples, while displaying virtual object creation user interface (e.g., an XR setting creation user interface, a user interface for generating, designing, and/or creating a virtual or XR setting, a user interface for generating, designing and/or creating virtual objects and/or XR objects, etc.), the electronic device receives a first user input corresponding to a request to insert a first virtual object corresponding to the first real world object at a first location in a virtual environment (e.g., an XR environment), wherein a virtual model (e.g., an XR model) of the first real world object is not available on the electronic device. Additionally or alternatively, in some examples, in response to receiving the first user input, the electronic device initiates a process for generating the virtual model of the first real world object, including performing, using the one or more cameras, the one or more captures of the real world environment, including the first real world object, and displays a placeholder object at the first location in the virtual environment, wherein the placeholder object is based on an initial capture of the one or more captures of the first real world object. Additionally or alternatively, in some examples, the electronic device receives a second user input corresponding to a request to insert a second virtual object of a second real world object at a second location in the virtual environment, wherein a virtual model (e.g., an XR model) of the second real world object is available on the electronic device, and in response to receiving the second user input, the electronic device displays a representation of the virtual model of the second real world object at the second location in the virtual environment, without initiating a process for generating a virtual model of the second real world object.

Additionally or alternatively, in some examples, after initiating the process for generating the virtual model of the first real world object, the electronic device determines that generation of the virtual model of the first real world object has completed. Additionally or alternatively, in some examples, in response to determining that generation of the virtual model of the first real world object has been completed, the electronic device replaces the placeholder object with a representation of the virtual model of the first real world object.

Additionally or alternatively, before updating the representation of the first real world object to indicate the scanning progress of the first real world object, the representation of the first real world object is a photorealistic representation of the first real world object at the time of the first capture. For example, the device captures a photorealistic representation of the first real world object using the one or more cameras (e.g., a visible light camera) and displays the photorealistic representation in the representation of the real world environment (e.g., before scanning the first real world object). In some embodiments, modifying the first portion of the representation of the first real world object from having the first visual characteristic to having the second visual characteristic indicates the scanning progress of the first real world object (e.g., the second visual characteristic indicates that a portion the first real world object corresponding to the first portion of the representation of the first real world object has been scanned, has been marked for scanning, or will be scanned). In some embodiments, the second visual characteristic is a virtual modification of the representation of the first real world object (e.g., an augmented reality modification) and not a result of a change in the visual characteristic of the first real world object that is captured by the one or more cameras (e.g., and is optionally reflected in the representation of the first real world object). In some embodiments, after modifying the first portion of the first real world object to have the second visual characteristic, the first portion of the first real world object is no longer a photorealistic representation of the first portion of the first real world object (e.g., due to having the second visual characteristic).

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 800) are also applicable in an analogous manner to method 700 described above with respect to FIG. 7. For example, the scanning of objects described above with reference to method 700 optionally has one or more of the characteristics of displaying capture targets, etc., described herein with reference to other methods described herein (e.g., method 800). For brevity, these details are not repeated here.

The operations in the information processing methods described above are, optionally, implemented by running one or more functional modules in an information processing apparatus such as general-purpose processors (e.g., as described with respect to FIG. 2) or application specific chips. Further, the operations described above with reference to FIG. 7 are, optionally, implemented by components depicted in FIG. 2.

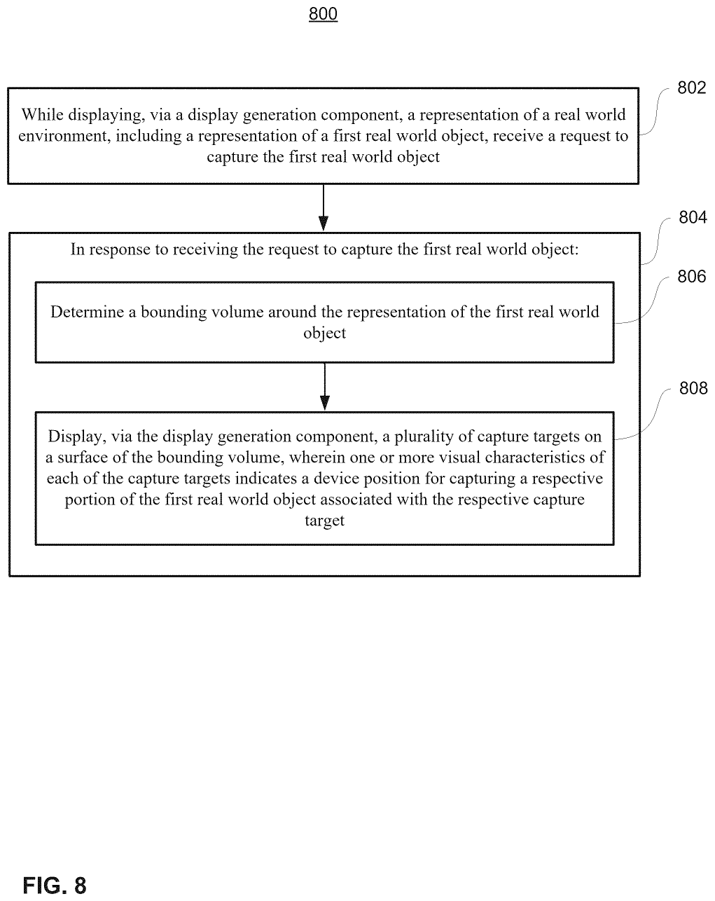

FIG. 8 is a flow diagram illustrating a method 800 of displaying capture targets in accordance with some embodiments of the disclosure. The method 800 is optionally performed at an electronic device such as device 100, device 200, device 300, device 400, device 500, and device 600 when performing object scanning described above with reference to FIGS. 1, 2-3, 4A-4B, 5A-5C, and 6A-6C. Some operations in method 800 are, optionally combined and/or order of some operations is, optionally, changed.

As described below, the method 800 provides ways to display capture targets in accordance with some embodiments of the disclosure (e.g., as discussed above with respect to FIGS. 5A-5C and 6A-6C).

In some examples, an electronic device in communication with a display (e.g., a display generation component, a display integrated with the electronic device (optionally a touch screen display), and/or an external display such as a monitor, projector, television, etc.) and one or more cameras (e.g., a mobile device (e.g., a tablet, a smartphone, a media player, or a wearable device), or a computer, optionally in communication with one or more of a visible light camera, a depth camera, a depth sensor, an infrared camera, and/or a capture device, etc.), while displaying, using the display, a representation of a real world environment, including a representation of a first real world object, receives (802) a request to capture the first real world object. In some examples, in response to receiving the request to capture the first real world object (804), the electronic device determines (804) a bounding volume around the representation of the first real world object, and displays (806), using the display, a plurality of capture targets on a surface of the bounding volume, wherein one or more visual characteristics of each of the capture targets indicates a device position for capturing a respective portion of the first real world object associated with the respective capture target.

Additionally or alternatively, in some examples, the request to capture the first real world object includes placing a reticle over the representation of the real world object (optionally for a threshold amount of time). Additionally or alternatively, in some examples, determining the bounding volume around the representation of the first real world object includes: identifying the first real world object in the real world environment, separate from other objects in the real world environment, and determining a physical characteristic (e.g., shape and/or size) of the first real world object.

Additionally or alternatively, in some examples, while displaying the plurality of capture targets on the surface of the bounding volume, the electronic device determines that a first camera of the one or more cameras is aligned with a first capture target of the one or more capture targets associated with the first portion of the first real world object. Additionally or alternatively, in some examples, in response to determining that the first camera is aligned with the first capture target, the electronic device performs, using the first camera, one or more captures of the first portion of the first real world object associated with the first capture target.

Additionally or alternatively, in some examples, in response to performing the one or more captures of the first portion of the first real world object, the electronic device modifies the first capture target to indicate a progress of the capture. Additionally or alternatively, in some examples, generating the bounding volume around the representation of the real world object includes receiving, via one or more input devices, a user input modifying a size of the bounding volume.

Additionally or alternatively, in some examples, while displaying the plurality of capture targets on the surface of the bounding volume, suggesting a first capture target of the plurality of capture targets, including the electronic device modifies, via the display generation device, the first capture target to have a first visual characteristic. Additionally or alternatively, in some examples, while displaying the first capture target with the first visual characteristic, the electronic device determines that a first camera of the one or more cameras is aligned with the first capture target.

Additionally or alternatively, in some examples, in response to determining that the first camera is aligned with the first capture target and while the first camera is aligned with the first capture target, the electronic device modifies, via the display generation device, the first capture target to have a second visual characteristic, different from the first visual characteristic, and performs, using the first camera, one or more captures of the first portion of the first real world object associated with the first capture target. Additionally or alternatively, in some examples, after performing the one or more captures of the first portion of the first real world object, the electronic device modifies, via the display generation device, the first capture target to have a third visual characteristic, different from the first visual characteristic and the second visual characteristic.

Additionally or alternatively, in some examples, suggesting the first capture target of the plurality of capture targets includes determining that the first capture target is a closest capture target to a reticle displayed by the display generation device. Additionally or alternatively, in some examples, modifying the first capture target to have the first visual characteristic includes changing a color of a portion of the first capture target. Additionally or alternatively, in some examples, modifying the first capture target to have the second visual characteristic includes changing the color of the portion of the first capture target. Additionally or alternatively, in some examples, modifying the first capture target to have the third visual characteristic includes ceasing display of the first capture target.

It should be understood that the particular order in which the operations in FIG. 8 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 800) are also applicable in an analogous manner to method 800 described above with respect to FIG. 8. For example, the displaying of capture targets described above with reference to method 800 optionally has one or more of the characteristics of scanning objects, etc., described herein with reference to other methods described herein (e.g., method 700). For brevity, these details are not repeated here.

The operations in the information processing methods described above are, optionally, implemented by running one or more functional modules in an information processing apparatus such as general-purpose processors (e.g., as described with respect to FIG. 2) or application specific chips. Further, the operations described above with reference to FIG. 8 are, optionally, implemented by components depicted in FIG. 2.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1. A method, comprising:
at an electronic device in communication with a display and one or more cameras:
while displaying, using the display, a representation of a real world environment, including a representation of a first real world object, receiving a request to capture the first real world object;
in response to receiving the request to capture the first real world object:
determining a bounding volume around the representation of the first real world object; and
displaying, using the display, a plurality of capture targets on a surface of the bounding volume, wherein one or more visual characteristics of each of the capture targets indicates a device position for capturing a respective portion of the first real world object associated with the respective capture target.

2. The method of claim 1, wherein the request to capture the first real world object includes placing a reticle over the representation of the real world object.

3. The method of claim 1, wherein determining the bounding volume around the representation of the first real world object includes:
identifying the first real world object in the real world environment, separate from other objects in the real world environment; and
determining a physical characteristic of the first real world object.

4. The method of claim 1 further comprising:
while displaying the plurality of capture targets on the surface of the bounding volume, determining that a first camera of the one or more cameras is aligned with a first capture target of the one or more capture targets associated with the first portion of the first real world object; and
in response to determining that the first camera is aligned with the first capture target, performing, using the first camera, one or more captures of the first portion of the first real world object associated with the first capture target.

5. The method of claim 1, further comprising:
in response to performing the one or more captures of the first portion of the first real world object, modifying the first capture target to indicate a progress of the capture.

6. The method of claim 1, wherein generating the bounding volume around the representation of the real world object includes receiving, via one or more input devices, a user input modifying a size of the bounding volume.

7. The method of claim 1, further comprising:
while displaying the plurality of capture targets on the surface of the bounding volume, suggesting a first capture target of the plurality of capture targets, including modifying, via the display, the first capture target to have a first visual characteristic;
while displaying the first capture target with the first visual characteristic, determining that a first camera of the one or more cameras is aligned with the first capture target;
in response to determining that the first camera is aligned with the first capture target and while the first camera is aligned with the first capture target:
modifying, via the display, the first capture target to have a second visual characteristic, different from the first visual characteristic; and
performing, using the first camera, one or more captures of the first portion of the first real world object associated with the first capture target; and
after performing the one or more captures of the first portion of the first real world object, modifying, via the display, the first capture target to have a third visual characteristic, different from the first visual characteristic and the second visual characteristic.

8. The method of claim 7, wherein suggesting the first capture target of the plurality of capture targets includes determining that the first capture target is a closest capture target to a reticle displayed by the display.

9. The method of claim 7, wherein:
modifying the first capture target to have the first visual characteristic includes changing a color of a portion of the first capture target; and
modifying the first capture target to have the second visual characteristic includes changing the color of the portion of the first capture target.

10. The method of claim 7, wherein modifying the first capture target to have the third visual characteristic includes ceasing display of the first capture target.

11. An electronic device, comprising:
one or more processors;
memory; and
wherein the one or more processors are configured to:
while displaying, using a display, a representation of a real world environment, including a representation of a first real world object, receive a request to capture the first real world object;
in response to receiving the request to capture the first real world object, determine a bounding volume around the representation of the first real world object; and
display, using the display, a plurality of capture targets on a surface of the bounding volume, wherein one or more visual characteristics of each of the capture targets indicates a device position for capturing a respective portion of the first real world object associated with the respective capture target.

12. The electronic device of claim 11, wherein receiving the request to capture the first real world object includes placing a reticle over the representation of the real world object.

13. The electronic device of claim 11, wherein determining the bounding volume around the representation of the first real world object includes:
identifying the first real world object in the real world environment, separate from other objects in the real world environment; and
determining a physical characteristic of the first real world object.

14. The electronic device of claim 11, wherein the one or more processors are further configured to:
while displaying the plurality of capture targets on the surface of the bounding volume, determine that a first camera of the one or more cameras is aligned with a first capture target of the one or more capture targets associated with the first portion of the first real world object; and
in response to determining that the first camera is aligned with the first capture target, perform, using the first camera, one or more captures of the first portion of the first real world object associated with the first capture target.

15. The electronic device of claim 11, wherein the one or more processors are further configured to:
in response to performing the one or more captures of the first portion of the first real world object, modify the first capture target to indicate a progress of the capture.

16. A non-transitory computer readable storage medium storing one or more programs, the one or more programs comprising instructions, which when executed by one or more processors of an electronic device, cause the electronic device to:
while displaying, using a display, a representation of a real world environment, including a representation of a first real world object, receive a request to capture the first real world object;
in response to receiving the request to capture the first real world object, determine a bounding volume around the representation of the first real world object; and
display, using the display, a plurality of capture targets on a surface of the bounding volume, wherein one or more visual characteristics of each of the capture targets indicates a device position for capturing a respective portion of the first real world object associated with the respective capture target.

17. The non-transitory computer readable storage medium of claim 16, wherein receiving the request to capture the first real world object includes placing a reticle over the representation of the real world object.

18. The non-transitory computer readable storage medium of claim 16, wherein determining the bounding volume around the representation of the first real world object includes:
identifying the first real world object in the real world environment, separate from other objects in the real world environment; and
determining a physical characteristic of the first real world object.

19. The non-transitory computer readable storage medium of claim 16, wherein the one or more programs further comprise instructions, which when executed by one or more processors of an electronic device, cause the electronic device to:
while displaying the plurality of capture targets on the surface of the bounding volume, determine that a first camera of the one or more cameras is aligned with a first capture target of the one or more capture targets associated with the first portion of the first real world object; and
in response to determining that the first camera is aligned with the first capture target, perform, using the first camera, one or more captures of the first portion of the first real world object associated with the first capture target.

20. The non-transitory computer readable storage medium of claim 16, wherein the one or more programs further comprise instructions, which when executed by one or more processors of an electronic device, cause the electronic device to:
in response to performing the one or more captures of the first portion of the first real world object, modify the first capture target to indicate a progress of the capture.
